(19) United States
(12) Patent Application Publication
(10) Pub. No.: US 2023/0025708 A1
(43) Pub. Date: Jan. 26, 2023

(54) MAINTENANCE SUPPORT SYSTEM, MAINTENANCE SUPPORT DEVICE, AND CONTROL METHOD THEREOF

(71) Applicant: TOSHIBA TEC KABUSHIKI KAISHA, Tokyo (JP)

(72) Inventor: Kiharu Mochizuki, Fuji Shizuoka (JP)

(21) Appl. No.: 17/718,349

(22) Filed: Apr. 12, 2022

(30) Foreign Application Priority Data
Jul. 21, 2021 (JP) 2021-120500

(51) Int. Cl. G06Q 20/20; G07G 1/00; G07G 1/14; G06T 7/70

(52) U.S. Cl. CPC G06Q 20/202; G07G 1/0009; G07G 1/14; G06T 7/70

(57) ABSTRACT

According to one embodiment, a maintenance support device includes a first acquisition unit, a second acquisition unit, a generation unit, and an output unit. The first acquisition unit acquires first image data displayed on a screen of a display unit of a merchandise registration device. The second acquisition unit acquires operation data related to an operation of the merchandise registration device. The generation unit generates second image data including the first image data and the operation data corresponding to the first image data in time. The output unit outputs the second image data generated by the generation unit.

### CROSS-REFERENCE TO RELATED APPLICATION

This application is based upon and claims the benefit of priority from Japanese Patent Application No. 2021-120500, filed on Jul. 21, 2021, the entire contents of which are incorporated herein by reference.

### FIELD

Embodiments described herein relate generally to a maintenance support system, a maintenance support device, and a control method thereof.

### BACKGROUND

A merchandise registration device such as a point of sales (POS) terminal has a log management function. For example, the log management function is a function of recording and managing, as a log, occurrences such as an update process for updating a version of an application program, an input operation of the merchandise registration device by an operator, and a defect in the merchandise registration device. For example, if the defect occurs in the merchandise registration device, a worker performing maintenance work searches for a cause of the defect by analyzing the log. However, it may be difficult to specify the defect only from information on the log. In this case, for example, the worker may be able to specify the defect by separately confirming what kind of image is displayed on a screen of a touch panel of the merchandise registration device if the defect occurs. Therefore, there is a demand for a mechanism capable of efficiently performing the maintenance work.

### DESCRIPTION OF THE DRAWINGS

FIG. 1 is a schematic diagram showing a schematic configuration of a maintenance support system according to an embodiment;

FIG. 2 is a block diagram showing a main circuit configuration of a POS terminal;

FIG. 3 is a schematic diagram showing an example of a data structure of an operation file;

FIG. 4 is a block diagram showing a main circuit configuration of a maintenance support server;

FIG. 5 is a schematic diagram showing an example of a management data record stored in a management database;

FIG. 6 is a block diagram showing a main circuit configuration of a worker terminal;

FIG. 7 is a flowchart showing a main control procedure of a processor in the POS terminal;

FIG. 8 is a flowchart showing a main control procedure of a processor in the maintenance support server;

FIG. 9 is a flowchart showing a main control procedure of a processor in the worker terminal;

FIG. 10 is a flowchart showing the main control procedure of the processor in the maintenance support server;

FIG. 11 is a schematic diagram showing an example of a result list screen; and

FIG. 12 is a schematic diagram showing an example of a maintenance support screen.

### DETAILED DESCRIPTION

A problem to be solved by embodiments is to provide a maintenance support system, a maintenance support device, and a control method thereof capable of efficiently performing maintenance work of a merchandise registration device.

In general, according to one embodiment, a maintenance support device includes a first acquisition means, a second acquisition means, a generation means, and an output means. The first acquisition means acquires first image data displayed on a screen of a display unit of a merchandise registration device. The second acquisition means acquires operation data related to an operation of the merchandise registration device. The generation means generates second image data including the first image data and the operation data corresponding to the first image data in time. The output means outputs the second image data generated by the generation means.

Hereinafter, an embodiment will be described with reference to the drawings.

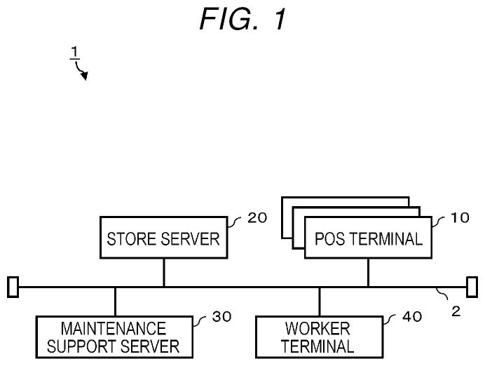

FIG. 1 is a schematic diagram showing a schematic configuration of a maintenance support system 1 according to an embodiment.

The maintenance support system 1 includes a plurality of POS terminals 10, a store server 20, a maintenance support server 30, and a worker terminal 40. The POS terminal 10, the store server 20, the maintenance support server 30, and the worker terminal 40 are connected to a communication network 2 such as a local area network (LAN).

The POS terminal 10 registers sales data of purchased merchandise purchased by a customer (a sales point of merchandise, a sales amount, and the like), and calculates the price to be paid by the customer based on the registered sales data. The POS terminal 10 receives payment and settles a commercial transaction with the customer. The POS terminal 10 can also be referred to as a merchandise registration device.

The store server 20 manages a merchandise database. The merchandise database stores a merchandise data record that records data of merchandise being sold in a store. The merchandise data record includes items such as a merchandise code, a merchandise name, a unit price, and the like. The merchandise code is merchandise identification information set on a per merchandise item basis in order to individually identify the merchandise. Each merchandise is usually attached with a barcode representing the merchandise code.

The maintenance support server 30 generates a maintenance support screen based on data collected from each POS terminal 10. The maintenance support screen will be described later. The maintenance support server 30 provides the generated maintenance support screen to the worker terminal 40. The maintenance support server 30 can also be referred to as a maintenance support device.

The worker terminal 40 is a terminal to be used if a worker performing maintenance work on the POS terminal 10 performs the maintenance work. The worker terminal 40 is an electronic device such as a tablet terminal, a notebook computer, and the like.

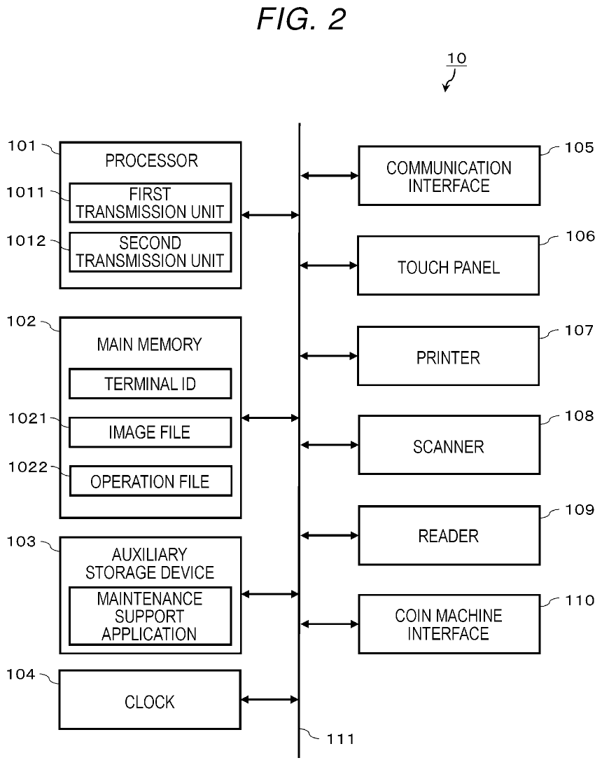

FIG. 2 is a block diagram showing a main circuit configuration of the POS terminal 10. The POS terminal 10 includes a processor 101, a main memory 102, an auxiliary storage device 103, a clock 104, a communication interface 105, a touch panel 106, a printer 107, a scanner 108, a reader 109, a coin machine interface 110, and a system transmission line 111. The POS terminal 10 electrically connects the processor 101, the main memory 102, the auxiliary storage device 103, the clock 104, the communication interface 105, the touch panel 106, the printer 107, the scanner 108, the reader 109, and the coin machine interface 110 to the system transmission line 111 directly or via a signal input and output circuit. The POS terminal 10 forms a computer by the processor 101, the main memory 102, the auxiliary storage device 103, and the system transmission line 111 connecting the processor 101, the main memory 102, and the auxiliary storage device 103.

The processor 101 corresponds to a central portion of the computer. The processor 101 controls each unit to implement various functions as the POS terminal 10 according to an operating system and an application program. The processor 101 is, for example, a central processing unit (CPU).

The main memory 102 corresponds to a main storage portion of the computer. The main memory 102 includes a non-volatile memory area and a volatile memory area. The main memory 102 stores the operating system and the application program in the non-volatile memory area. The main memory 102 may store data, which is necessary for the processor 101 to execute a process for controlling each unit, in the non-volatile or volatile memory area. The main memory 102 uses the volatile memory area as a work area where data is appropriately rewritten by the processor 101. The non-volatile memory area is, for example, a read only memory (ROM). The volatile memory area is, for example, a random access memory (RAM).

The auxiliary storage device 103 corresponds to an auxiliary storage portion of the computer. For example, an electric erasable programmable read-only memory (EEPROM) (registered trademark), a hard disc drive (HDD), a solid state drive (SSD), and the like are used as the auxiliary storage device 103. The auxiliary storage device 103 stores data to be used by the processor 101 for performing various processes and data generated by the process of the processor 101. The auxiliary storage device 103 may store the application program.

The application program stored in the auxiliary storage device 103 includes a maintenance support application program. Hereinafter, the maintenance support application program is abbreviated as a maintenance support application. The maintenance support application is an application for acquiring, at a constant cycle, image data of a frame image (a captured image) displayed on a screen of the touch panel 106 of the POS terminal 10 installed in a store where the maintenance support system 1 is adopted. The constant cycle is, for example, one second. The way of setting the constant cycle is freely selected. The image data of the frame image can also be referred to as first image data. A method for installing the maintenance support application in the auxiliary storage device 103 is not particularly limited. The maintenance support application can be installed in the auxiliary storage device 103 by recording a control program in a removable recording medium or distributing the control program by communication via a network. The recording medium may be in any form as long as the recording medium can store a program in the same manner as that of a CD-ROM, a memory card, and the like, and can be read by a device. The maintenance support application may be installed in the main memory 102 instead of the auxiliary storage device 103.

The clock 104 functions as a time information source of the POS terminal 10. The processor 101 tracks a current date and time (a date and time) based on time information tracked by the clock 104.

The communication interface 105 is connected to the communication network 2. The communication interface 105 performs data communication with another device connected via the communication network 2 according to a communication protocol.

The touch panel 106 functions as an input device and a display device of the POS terminal 10. The touch panel 106 detects a touch location of a displayed image and outputs the touch location information to the processor 101. The touch panel 106 can also be referred to as a display unit (a first display unit) of the POS terminal 10.

The printer 107 performs printing on receipt paper. The printed receipt paper is dispensed as, for example, a purchase receipt, a credit slip, and the like. The printer 107 is, for example, a thermal printer, an inkjet printer, and the like.

The scanner 108 reads a code symbol such as a barcode, a two-dimensional data code, and the like attached to merchandise, and outputs the read data to the processor 101. The scanner 108 may be of a type that reads the code symbol by laser beam scanning, or may be a type that reads the code symbol from an image captured by an image capturing device.

The reader 109 reads the data recorded in the recording medium and outputs the read data to the processor 101. The reader 109 is a magnetic card reader if the recording medium is a magnetic card, and is an IC card reader if the recording medium is a contact type IC card. In the case of the recording medium using radio frequency identification (RFID) such as a non-contact type IC card or a smartphone, an RFID reader is used as the reader 109.

The input and output of a data signal are performed between the coin machine interface 110 and an automatic coin machine. For example, the coin machine interface 110 inputs input amount data from the automatic coin machine. The coin machine interface 110 outputs coin amount data to the automatic coin machine. In the automatic coin machine, a banknote or a coin corresponding to a coin amount according to the coin amount data is paid out.

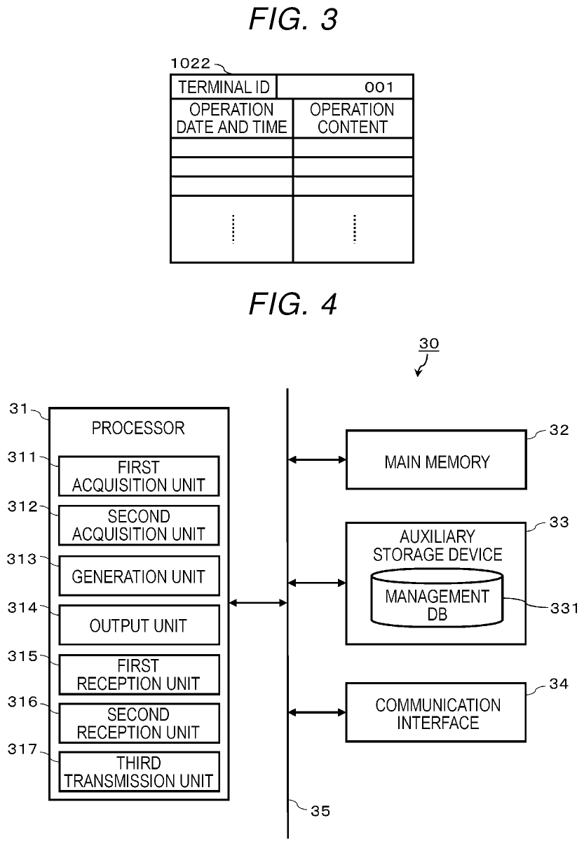

The POS terminal 10 having such a configuration stores the terminal ID in the non-volatile memory area of the main memory 102. The terminal ID is terminal identification information set for each POS terminal 10 in order to individually identify each POS terminal 10. The POS terminal 10 uses a part of the volatile memory area of the main memory 102 as an area of an image file 1021 and an operation file 1022 (refer to FIG. 3). The image data of the frame image acquired at a constant cycle are stored in time series in the image file 1021. In the operation file 1022, an operation date and time and an operation content, which will be described later, are described in association with each other. A storage destination of the terminal ID, the image file 1021, and the operation file 1022 is not limited to the main memory 102. The terminal ID, the image file 1021, and the operation file 1022 may be stored in the auxiliary storage device 103.

FIG. 3 is a schematic diagram showing an example of a data structure of the operation file 1022. As shown in FIG. 3, the operation file 1022 is a data file in which the operation date and time and the operation content are described in association with each other for each terminal ID. The operation date and time is a date and time when an operation of the POS terminal 10 occurs. For example, in the case of 15:30:10 on Jul. 1, 2021, “20210701153010” is described as the operation date and time. Examples of an operation of recording as a log in the POS terminal 10 include: executing an update process to update a version of an application program; performing an operation input to the POS terminal 10 by an operator; communication connection between the POS terminal 10 and other devices; and a defect (an error) occurrence in the POS terminal 10. The operation input to the POS terminal 10 is, for example, touching the touch panel 106, reading the code symbol with the scanner 108, and the like. The operation content is the details of generated operations such as “update process start”, “communication connection end”, and “error message display”. In the operation file 1022, the operation contents are described in the order of the earliest operation date and time. The operation date and time and the operation content can also be referred to as operation data related to the operation of the POS terminal 10.

The processor 101 has a function as a first transmission unit 1011 and a second transmission unit 1012. The first transmission unit 1011 has a function of transmitting first image data displayed on a screen of the first display unit, that is, the touch panel 106, to the maintenance support device, that is, the maintenance support server 30.

The second transmission unit 1012 has a function of transmitting the operation data related to the operation of the merchandise registration device, that is, the POS terminal 10, to the maintenance support device, that is, the maintenance support server 30.

FIG. 4 is a block diagram showing a main circuit configuration of the maintenance support server 30. As shown in FIG. 4, the maintenance support server 30 includes a processor 31, a main memory 32, an auxiliary storage device 33, a communication interface 34, and a system transmission line 35. The system transmission line 35 includes an address bus, a data bus, a control signal line, and the like. The maintenance support server 30 connects the processor 31, the main memory 32, the auxiliary storage device 33, and the communication interface 34 to the system transmission line 35. A computer, as the maintenance support server 30, is configured by the processor 31, the main memory 32, the auxiliary storage device 33, and the system transmission line 35 that connects the processor 31, the main memory 32, and the auxiliary storage device 33.

The processor 31 corresponds to a central portion of the computer. The processor 31 controls each unit to implement various functions as the maintenance support server 30 according to an operating system or an application program. The processor 31 is, for example, a CPU.

The main memory 32 corresponds to a main storage portion of the computer. The main memory 32 includes a non-volatile memory area and a volatile memory area. The main memory 32 stores an operating system or an application program in the non-volatile memory area. The main memory 32 may store data, which is necessary for the processor 31 to execute a process for controlling each unit, in the non-volatile or volatile memory area. The main memory 32 uses the volatile memory area as a work area in which data is appropriately rewritten by the processor 31. The non-volatile memory area is, for example, a ROM. The volatile memory area is, for example, a RAM.

The auxiliary storage device 33 corresponds to an auxiliary storage portion of the computer. For example, an EEPROM, an HDD, or an SSD may be the auxiliary storage device 33. The auxiliary storage device 33 stores data to be used by the processor 31 for performing various types of processes, or data generated by the process by the processor 31. The auxiliary storage device 33 may store the application program.

The communication interface 34 is connected to the communication network 2. The communication interface 34 performs data communication with another device connected via the communication network 2 according to a communication protocol.

The maintenance support server 30 having such a configuration stores the management database 331 in the auxiliary storage device 33.

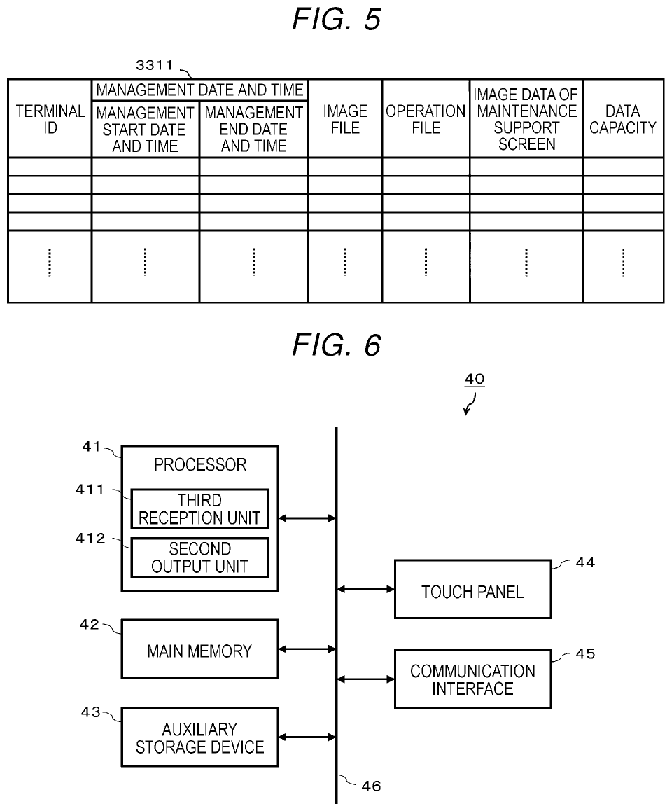

FIG. 5 is a schematic diagram showing an example of a management data record 3311 stored in the management database 331. As shown in FIG. 5, the management data record 3311 includes a terminal ID, a management date and time, an image file, an operation file, image data of the maintenance support screen, a data capacity, and the like. The management date and time includes a management start date and time and a management end date and time. The management start date and time and the management end date and time will be described later. The data capacity is a capacity of the image data of the maintenance support screen. The management data record 3311 is not limited to the data of the above-described items.

The processor 31 has functions as a first acquisition unit 311, a second acquisition unit 312, a generation unit 313, an output unit 314, a first reception unit 315, a second reception unit 316, and a third transmission unit 317. The first acquisition unit 311 has a function of acquiring first image data displayed on the display unit of the merchandise registration device, that is, the screen of the touch panel 106 of the POS terminal 10.

The second acquisition unit 312 has a function of acquiring the operation data related to the operation of the merchandise registration device, that is, the POS terminal 10.

The generation unit 313 has a function of generating second image data including the first image data and operation data corresponding to the first image data in time.

The output unit 314 includes the following two functions. A first function is a function of outputting the second image data generated by the generation unit 313. A second function is a function of outputting a list of information for specifying the second image data.

The first reception unit 315 has a function of receiving the first image data transmitted by the first transmission unit 1011.

The second reception unit 316 has a function of receiving the operation data transmitted by the second transmission unit 1012.

The third transmission unit 317 has a function of transmitting the second image data generated by the generation unit 313 to the worker terminal 40. The third transmission unit 317 functions as the output unit 314 for the worker terminal 40.

FIG. 6 is a block diagram showing a main circuit configuration of the worker terminal 40. As shown in FIG. 6, the worker terminal 40 includes a processor 41, a main memory 42, an auxiliary storage device 43, a touch panel 44, a communication interface 45, and a system transmission line 46. The system transmission line 46 includes an address bus, a data bus, a control signal line, and the like. The worker terminal 40 connects the processor 41, the main memory 42, the auxiliary storage device 43, the touch panel 44, and the communication interface 45 to the system transmission line 46. In the worker terminal 40, a computer is configured by the processor 41, the main memory 42, the auxiliary storage device 43, and the system transmission line 46 connecting the processor 41, the main memory 42, and the auxiliary storage device 43.

The processor 41 corresponds to a central portion of the computer. The processor 41 controls each unit to implement various functions as the worker terminal 40 according to an operating system or an application program. The processor 41 is, for example, a CPU.

The main memory 42 corresponds to a main storage portion of the computer. The main memory 42 includes a non-volatile memory area and a volatile memory area. The main memory 42 stores the operating system or the application program in the non-volatile memory area. The main memory 42 may store data, which is necessary for the processor 41 to execute a process for controlling each unit, in the non-volatile or volatile memory area. The main memory 42 uses the volatile memory area as a work area in which data is appropriately rewritten by the processor 41. The non-volatile memory area is, for example, a ROM. The volatile memory area is, for example, a RAM.

The auxiliary storage device 43 corresponds to an auxiliary storage portion of the computer. For example, an EEPROM, an HDD, or an SSD may be the auxiliary storage device 43. The auxiliary storage device 43 stores data to be used by the processor 41 for performing various types of processes, or data generated by the process by the processor 41. The auxiliary storage device 43 may store the application program.

The touch panel 44 functions as an input device and a display device of the worker terminal 40. The touch panel 44 detects a touch location of a displayed image and outputs the touch location information to the processor 41. The touch panel 44 can also be referred to as a second display unit.

The communication interface 45 is connected to the communication network 2. The communication interface 45 performs data communication with another device connected via the communication network 2 according to a communication protocol.

The processor 41 has a function as a third reception unit 411 and a second output unit 412. The third reception unit 411 has a function of receiving the second image data transmitted by the third transmission unit 317.

The second output unit 412 has a function of outputting the second image data to the second display unit, that is, the touch panel 44.

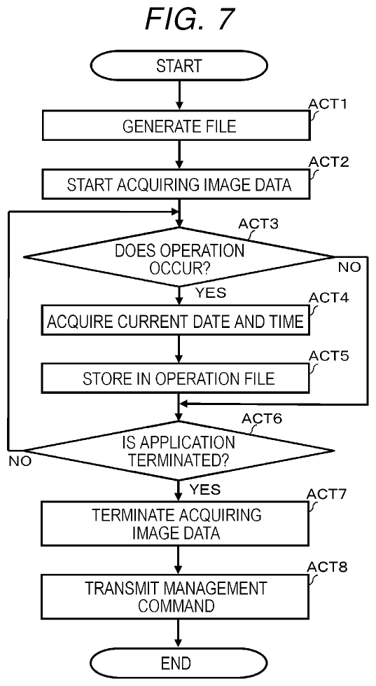

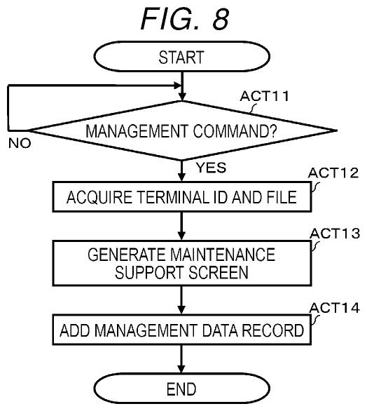

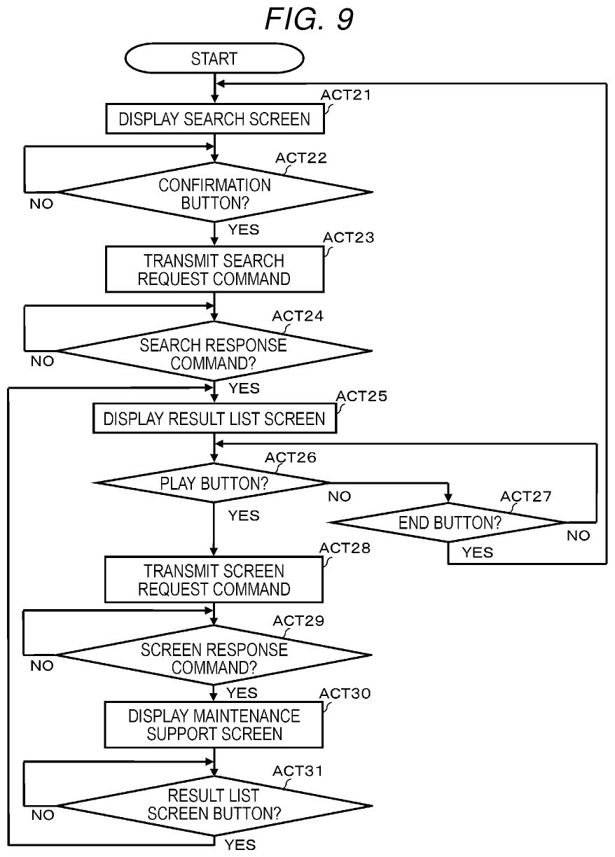

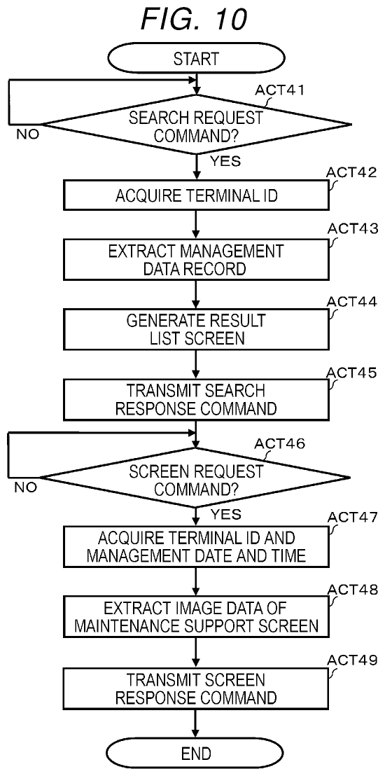

FIG. 7 is a flowchart showing a procedure of a main information process executed by the processor 101 of the POS terminal 10. FIGS. 8 and 10 are flowcharts showing a procedure of a main information process executed by the processor 31 of the maintenance support server 30. FIG. 9 is a flowchart showing a procedure of a main information process executed by the processor 41 of the worker terminal 40. Hereinafter, an operation of the maintenance support system 1 will be described with reference to the drawings. The operation described hereinafter is an example. As long as a similar result can be obtained, the procedure and the like are not particularly limited.

A person in charge of a settlement operation of a store, who is an operator of the POS terminal 10, first starts the POS terminal 10. The person also starts the maintenance support application installed in the POS terminal 10 with the start of the POS terminal 10. If the maintenance support application is started, the processor 101 of the POS terminal 10 starts the information process of the procedure shown in the flowchart of FIG. 7.

In ACT 1, the processor 101 generates the image file 1021 and the operation file 1022 in the non-volatile memory area in the main memory 102. Each time the image file 1021 is generated therein, the processor 101 adds a file name to the image file 1021. The file name is unique, and another image file 1021 and the file name do not overlap each other. The file name of the image file 1021 may include, for example, a terminal ID, and a date and time at the time of generation of the image file 1021.

The processor 101 starts acquiring image data of a frame image displayed on the screen of the touch panel 106 of the POS terminal 10 in ACT 2. Each time the processor 101 acquires the image data of the frame image, the processor 101 stores the acquired image data in the image file 1021. The processor 101 adds a data name to each image data. The data name includes a date and time at the time of acquiring the image data tracked by the clock 104.

The processor 101 waits for various operations to occur in ACT 3. If the operation occurs, the processor 101 determines YES in ACT 3 and proceeds to ACT 4.

The processor 101 acquires a current date and time tracked by the clock 104 in ACT 4. The processor 101 stores the current date and time acquired in the process of ACT 4 and a generated operation content in association with each other in the operation file 1022 in ACT 5. Next, the processor 101 proceeds to ACT 6.

If the operation does not occur, the processor 101 determines NO in ACT 3, skips the processes of ACTS 4 and 5, and proceeds to ACT 6.

The processor 101 confirms whether or not the maintenance support application is terminated in ACT 6. If the processor 101 recognizes that a termination operation for terminating the maintenance support application is performed, the processor 101 recognizes that the maintenance support application is terminated. For example, if the person in charge of the settlement operation touches an end button of the maintenance support application after the store is closed every business day, the processor 101 recognizes that the maintenance support application is terminated. If the maintenance support application is not terminated, the processor 101 determines NO in ACT 6 and returns to ACT 3. That is, the processor 101 executes the processes of ACT 3 to ACT 6 in the same manner as described above.

If the maintenance support application is terminated, the processor 101 determines YES in ACT 6 and proceeds to ACT 7. The processor 101 terminates the acquisition of the image data of the frame image in ACT 7.

The processor 101 controls the communication interface 105 so as to transmit a management command to the maintenance support server 30 by the functions of the first transmission unit 1011 and the second transmission unit 1012 in ACT 8. By this control, the management command is transmitted via the communication interface 105. The management command is received by the maintenance support server 30 via the communication network 2. The management command includes the terminal ID, the image file 1021, and the operation file 1022. As described above, the processor 101 terminates the information process of the procedure shown in the flowchart of FIG. 7.

The processor 31 of the maintenance support server 30 waits for receiving the management command from the POS terminal 10 in ACT 11 of FIG. 8. When receiving the management command by the functions of the first reception unit 315 and the second reception unit 316, the processor 31 determines YES in ACT 11 and proceeds to ACT 12.

The processor 31 acquires the terminal ID, the image file 1021, and the operation file 1022 from the management command by the functions of the first acquisition unit 311 and the second acquisition unit 312 in ACT 12.

The processor 31 generates a maintenance support screen based on the image file 1021 and the operation file 1022 acquired in the process of ACT 12 by the function of the generation unit 313 in ACT 13.

The processor 31 adds the management data record 3311 to the management database 331 in ACT 14. Specifically, the processor 31 stores, in the management database 331, the terminal ID, the image file 1021, the operation file 1022, which are acquired by the process of ACT 12, the image data of the maintenance support screen generated in the process of ACT 13, the data capacity of the image data of the maintenance support screen, and the management date and time (the management start date and time and the management end date and time) in association with each other. The management start date and time is, for example, an operation date and time described earliest in the operation file 1022. The management end date and time is, for example, an operation date and time described at the latest in the operation file 1022. The management start date and time and the management end date and time shall be the same day. As described above, the processor 31 terminates the information process of the procedure shown in the flowchart of FIG. 8.

Here, the worker who performs the maintenance work of the POS terminal 10 connects the worker terminal 40 to the maintenance support server 30 via the communication network 2. If the connection between the worker terminal 40 and the maintenance support server 30 is completed, the processor 41 starts the information process of the procedure shown in the flowchart of FIG. 9.

The processor 41 displays a search screen on the touch panel 44 in ACT 21. The search screen is a screen for searching for the maintenance support screen desired to be viewed. On the search screen, for example, an input field for inputting the terminal ID of the POS terminal 10 that performs the maintenance work, and a confirmation button for inputting an instruction about input confirmation are displayed. The confirmation button is touched if the terminal ID is input in the input field. The confirmation button may be enabled, for example, if the terminal ID is input in the input field. For example, the confirmation button may be displayed with a gray scale until the terminal ID is input in the input field.

The processor 41 waits for the confirmation button to be touched in ACT 22. If the confirm button is touched, the processor 41 determines YES in ACT 22 and proceeds to ACT 23.

The processor 41 controls the communication interface so as to transmit a search request command to the maintenance support server 30 in ACT 23. By this control, the search request command is transmitted thereto via the communication interface 45. The search request command is received by the maintenance support server 30 via the communication network 2. The search request command includes the terminal ID.

The processor 31 of the maintenance support server 30 waits for receiving the search request command from the worker terminal 40 in ACT 41 of FIG. 10. When receiving the search request command, the processor 31 determines YES in ACT 41 and proceeds to ACT 42.

The processor 31 acquires the terminal ID from the search request command in ACT 42. In ACT 43, the processor extracts, from the management database 331, all the management data records 3311 including the terminal ID acquired in the process of ACT 42.

In ACT 44, the processor 31 generates a result list screen based on the management data record 3311 extracted in the process of ACT 43. The result list screen will be described later.

The processor 31 controls the communication interface 34 so as to transmit a search response command to the worker terminal 40 by the function of the output unit 314 in ACT 45. By this control, the search response command is transmitted via the communication interface 34. The search response command is received by the worker terminal 40 via the communication network 2. The search response command includes image data of the result list screen generated in the process of ACT 44.

Referring back to FIG. 9, the processor 41 transmitting the search request command waits for receiving the search response command in ACT 24. When receiving the search response command, the processor 41 determines YES in ACT 24 and proceeds to ACT 25.

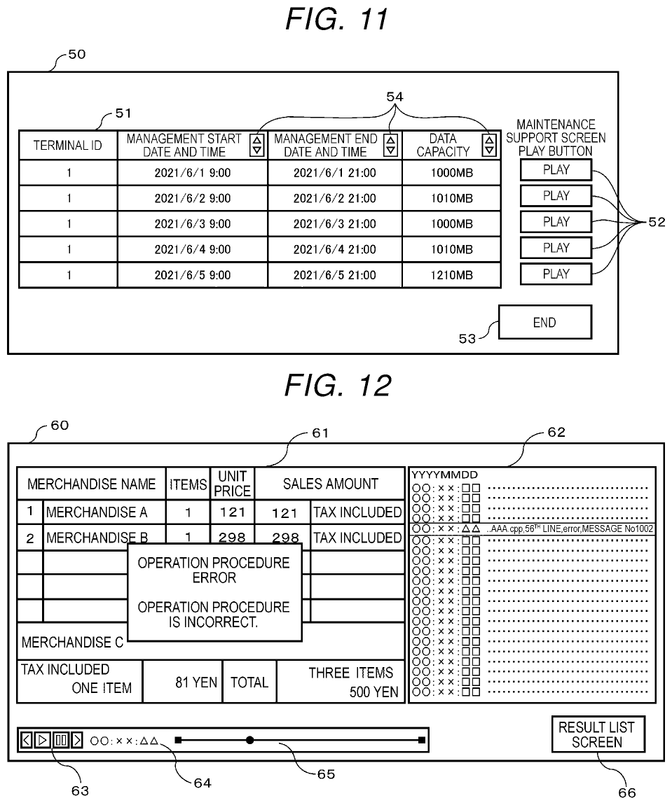

The processor 41 causes the touch panel 44 to display a result list screen 50 (refer to FIG. 11) in ACT 25.

FIG. 11 is a schematic diagram showing an example of the result list screen 50. As shown in FIG. 11, the result list screen 50 includes a list area 51, an image of a play button 52, and an image of an end button 53. The list area 51 includes a list of the terminal ID, the management date and time (the management start date and the time, and the management end date and time), and the data capacity included in the management data record 3311, and an image of a sort button 54. The sort button 54 is touched if sorting is performed according to the order of priority. The sort button 54 is touched, for example, if sorting is performed in the order of early or late management date and time. The sort button 54 is touched, for example, if sorting is performed in the order of small or large data capacity. The play button 52 is displayed corresponding to each row displayed in the list area 51. The play button 52 is touched when playing the maintenance support screen desired to be viewed from the list area 51. The end button 53 is touched when returning to the search screen. The result list screen 50 can also be referred to as a list of information for specifying the second image data. The second image data will be described later. A content of text data displayed in FIG. 11 is an example.

Referring back to FIG. 9, the processor 41 confirms whether or not the play button 52 is touched in ACT 26. If the play button 52 is not touched, the processor 41 determines NO in ACT 26 and proceeds to ACT 27.

The processor 41 confirms whether or not the end button 53 is touched in ACT 27. If the end button 53 is not touched, the processor 41 determines NO in ACT 27 and returns to ACT 26.

If the play button 52 is touched in a standby state of ACTS 26 and 27, the processor 41 determines YES in ACT 26 and proceeds to ACT 28.

The processor 41 controls the communication interface 45 to transmit a screen request command to the maintenance support server 30 in ACT 28. By this control, the screen request command is transmitted via the communication interface 45. The screen request command is received by the maintenance support server 30 via the communication network 2. The screen request command includes the terminal ID and the management date and time included in a row displayed in the list area 51 corresponding to the play button 52.

The processor 31 of the maintenance support server 30 waits for receiving the screen request command from the worker terminal 40 in ACT 46 of FIG. 10. When receiving the screen request command therefrom, the processor 31 determines YES in ACT 46 and proceeds to ACT 47.

The processor 31 acquires the terminal ID and the management date and time from the screen request command in ACT 47. The processor 31 extracts the image data of the maintenance support screen in ACT 48. Specifically, the processor 31 extracts, from the management database 331, the management data record 3311 including the terminal ID and the management date and time acquired in the process of ACT 47. The processor 31 extracts the image data of the maintenance support screen included in the management data record 3311.

The processor 31 controls the communication interface 34 so as to transmit a screen response command to the worker terminal 40 by the function of the output unit 314 (the third transmission unit 317) in ACT 49. By this control, the screen response command is transmitted thereto via the communication interface 34. The screen response command is received by the worker terminal 40 via the communication network 2. The screen response command includes the image data of the maintenance support screen acquired in the process of ACT 48. As described above, the processor 31 terminates the information process of the procedure shown in the flowchart of FIG. 10.

Referring back to FIG. 9, the processor 41 transmitting the screen request command waits for the screen response command in ACT 29. When receiving the screen response command by the function of the third reception unit 411, the processor 41 determines YES in ACT 29 and proceeds to ACT 30.

The processor 41 causes the touch panel 44 to display a maintenance support screen 60 (refer to FIG. 12) by the function of the second output unit 412 in ACT 30.

FIG. 12 is a schematic diagram showing an example of the maintenance support screen 60. As shown in FIG. 12, the maintenance support screen 60 includes a frame image display area 61, an operation display area 62, an operation button display area 63, a time display area 64, a seek bar 65, and an image of a result list screen button 66. In the frame image display area 61, image data of a frame image is displayed in time series. A list of operation data is displayed in the operation display area 62. In the list of operation data, according to the image data of the frame image displayed in time series, a row in which the operation data corresponding to the image data in time is displayed is updated to a selected state (for example, reverse display or display with a predetermined color). The operation button display area 63 includes an image of a play button, an image of a pause button, an image of a back button, and an image of a forward button. The play button is touched if the image data is desired to be played. The pause button is touched if the playing is desired to be temporarily paused. The back button is touched to go back to playback. The forward button is touched if a part of the playing is desired to be skipped. In the time display area 64, the time when the processor 101 of the POS terminal 10 acquires the image data of the frame image is displayed. If the seek bar 65 is tapped or dragged by an operator, the image data of the frame image of the time selected by the operator is displayed in the frame image display area 61, and in the operation display area 62, a row in which the operation data corresponding to the time is displayed becomes the selected state. The maintenance support screen 60 can also be referred to as the second image data including the first image data and the operation data corresponding to the first image data in time. The maintenance support screen 60 can also be referred to as image data that transitions over time.

In the case of FIG. 12, in the frame image display area 61, the image data of the frame image if a pop-up image is displayed on a merchandise registration screen displayed on the touch panel 106 of the POS terminal 10 is displayed. The merchandise registration screen is an image displayed on the screen of the touch panel 106 while the operator is performing a registration operation of the purchased merchandise. The merchandise registration screen includes, for example, a merchandise name, a point, a unit price, a sales amount of the registered purchased merchandise, a total point, and a total amount. The sales amount is an amount obtained by multiplying the unit price by the point. The total amount is the sum of the sales amounts. The pop-up image is an image for notifying an operation procedure error. In the operation display area 62, a row in which the operation data corresponding to the time if the pop-up image is displayed on the merchandise registration screen is displayed becomes the selected state. A content of text data displayed in FIG. 12 is an example.

Referring back to FIG. 9, the processor 41 displaying the maintenance support screen 60 on the touch panel 44 confirms whether or not the result list screen button 66 is touched in ACT 31. If the result list screen button 66 is touched, the processor 41 determines YES in ACT 31 and returns to ACT 25. That is, the processor 41 displays the result list screen 50 on the touch panel 44.

If the end button 53 is touched in the standby state of ACTS 26 and 27, the processor 41 determines YES in ACT 27 and returns to ACT 21. That is, the processor 41 executes the processes of ACT 21 to ACT 31 in the same manner as described above. As described above, the processor 41 terminates the information process of the procedure shown in the flowchart of FIG. 9.

Thus, according to the embodiment, if the maintenance support application is started, the acquisition of the image data of the frame image displayed on the screen of the touch panel 106 of the POS terminal 10 is started, and the acquired image data is stored in the image file 1021. If various operations of the POS terminal 10 occur, the current date and time and the generated operation content are stored in association with each other in the operation file 1022. The management command including the image file 1021, the operation file 1022, and the terminal ID is transmitted to the maintenance support server 30. The maintenance support server 30 receiving the management command generates the maintenance support screen 60 based on the image file 1021 and the operation file 1022. When receiving the screen request command from the worker terminal 40, the maintenance support server 30 transmits the screen response command including the image data of the maintenance support screen 60 to the worker terminal 40. The maintenance support screen 60 is displayed on the touch panel 44 of the worker terminal 40 receiving the screen response command. The maintenance support screen 60 includes the frame image display area 61 and the operation display area 62, thereby making it possible to simultaneously view the image data of the frame image and the operation of the POS terminal 10 corresponding to the image data in time. Therefore, the worker can efficiently perform the maintenance work.

If the maintenance support screen 60 is viewed, the result list screen 50 is displayed on the touch panel 44 of the worker terminal 40. In the list area 51 of the result list screen 50, a list of information for specifying the maintenance support screen 60 of the POS terminal 10, the terminal ID of which is input on the search screen, is displayed. Therefore, the worker can easily play the maintenance support screen 60 desired to be viewed from the list area 51.

The worker terminal 40 is connected to the maintenance support server 30 via the communication network 2, such that the search screen, the result list screen 50, and the maintenance support screen 60 are displayed on the touch panel 44. Therefore, even though a defect such as a failure and the like occurs in the POS terminal 10, a cause of the defect can be searched for by using the worker terminal 40. Therefore, it is possible to prevent the maintenance work from being delayed.

Hereinabove, the embodiment of the maintenance support system, the maintenance support device, and the control method thereof is described, and is not limited thereto.

The embodiment shows an example in which if the person in charge of settlement operation closes the store every business day and then performs an operation of terminating the maintenance support application, the processor 101 of the POS terminal 10 transmits the management command to the maintenance support server 30. The timing of transmitting the management command to the maintenance support server 30 may be, for example, a predetermined time after the operation of terminating the maintenance support application is performed. The way of setting the predetermined time is freely selected. The predetermined time may be a fixed time at the POS terminal 10, or may be changed to a desired time by the store that manages the POS terminal 10.

The embodiment shows an example in which the management data record 3311 included in the search response command is stored in a part of the volatile memory area in the main memory 42. For example, a storage destination of the management data record 3311 may be the auxiliary storage device 43 or a storage device externally attached to the worker terminal 40.

The embodiment shows an example in which the search screen displays the input field for inputting the terminal ID of the POS terminal 10 for performing the maintenance work and the confirmation button for inputting the instruction about the input confirmation. For example, an input field for inputting a defect occurrence date may be further displayed. The defect occurrence date is, for example, the date if the defect occurred in the POS terminal 10. In this case, the search request command includes the terminal ID and the defect occurrence date input in the input field of the search screen. When receiving the search request command from the worker terminal 40, the processor 31 of the maintenance support server 30 extracts the image data of the maintenance support screen 60 from the management data record 3311 including the terminal ID and the management start date and time or the management end date and time including the defect occurrence date. The processor 31 transmits the search response command including the image data of the maintenance support screen 60 to the worker terminal 40 from which the search request command is transmitted. The maintenance support screen 60 is displayed on the touch panel 44 of the worker terminal 40 receiving the search response command. That is, in this case, the processes of ACT 25 to ACT 29 in FIG. 9 can be omitted.

The embodiment shows an example in which the search screen displays the input field for inputting the terminal ID of the POS terminal 10 for performing the maintenance work and the confirmation button for inputting the instruction about the input confirmation. For example, on the search screen, the input field for inputting the defect occurrence date and the confirmation button for inputting the instruction about the input confirmation may be displayed. In this case, the search request command includes the defect occurrence date. When receiving the search request command from the worker terminal 40, the processor 31 of the maintenance support server 30 extracts all the management data records 3311 including the management start date and time or the management end date and time including the defect occurrence date from the management database 331, and generates the result list screen 50. If a plurality of terminal IDs are stored in the management database 331, a list including the plurality of terminal IDs is displayed in the list area 51 of the result list screen 50. In this case, the sort button 54 may be displayed in the item of the terminal ID of the result list screen 50. The sort button 54 is touched, for example, if sorting is performed in the order of small or large terminal ID. In this manner, for example, even though a defect occurs on the same day in a plurality of POS terminals 10 provided in a store, the maintenance support screen 60 of each POS terminal 10 can be easily played from the result list screen 50. Therefore, the worker can efficiently perform the maintenance work.

The embodiment shows an example in which the result list screen 50 includes the list area 51, the image of the play button 52, and the image of the end button 53. For example, an image of a delete button may be further provided. The delete button is displayed corresponding to each row displayed in the list area 51. The delete button is touched if the maintenance support screen 60 is deleted from the list area 51. For example, a case where the maintenance support screen 60 is deleted is a case where, as a result of viewing the maintenance support screen 60, it is confirmed that a defect does not occur. In this case, the processor 41 of the worker terminal 40 transmits, for example, a delete command to the maintenance support server 30. The delete command includes, for example, the terminal ID and the management date and time included in a row displayed in the list area 51 corresponding to the delete button. The processor 31 of the maintenance support server 30 receiving the delete command may delete the management data record 3311 including the terminal ID and the management date and time included in the delete command from the management database 331.

The embodiment shows an example in which the screen request command includes the terminal ID and the management date and time included in a row displayed in the list area 51 corresponding to the play button 52. For example, the management date and time may be only any one of the management start date and time and the management end date and time. For example, the screen request command may further include the data capacity.

The embodiment shows an example in which the maintenance support screen 60 is displayed on the touch panel 44 of the worker terminal 40. For example, the maintenance support screen 60 may be displayed on the touch panel 106 of the POS terminal 10.

The embodiment shows an example in which the maintenance support application is executed to acquire, at a constant cycle, the image data of the frame image displayed on the screen of the touch panel 106 of the POS terminal 10 installed in the store where the maintenance support system 1 is adopted. For example, a camera may be installed at a location where the touch panel 106 of the POS terminal 10 can be captured, and image-captured data output from the camera may be acquired. For example, a plurality of cameras may be installed to acquire image-captured data that captures an image of a transaction between an operator of the POS terminal 10 and a customer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A maintenance support device, comprising:
a first acquisition component for acquiring first image data displayed on a screen of a display of a merchandise registration device;
a second acquisition component for acquiring operation data related to an operation of the merchandise registration device;
a generation component for generating second image data including the first image data and the operation data corresponding to the first image data in time; and
an output component for outputting the second image data generated by the generation component.

2. The maintenance support device according to claim 1, wherein
the output component outputs a list of information for specifying the second image data.

3. The maintenance support device according to claim 1, wherein
the second image data is image data transitioned over time.

4. The maintenance support device according to claim 1, further comprising a component that acquires image data of a frame image displayed on the screen of the touch panel of the merchandise registration device, with each acquisition of the image data of the frame image, stores the acquired image data in an image file, and adds a data name to each image data, the data name including a date and time at a time of acquiring the image data.

5. The maintenance support device according to claim 1, wherein the first acquisition component acquires first image data displayed on the screen of a display of a plurality of merchandise registration devices.

6. The maintenance support device according to claim 5, wherein
the generation component generates a maintenance support screen based on data collected from each of the plurality of merchandise registration devices.

7. The maintenance support device according to claim 1, wherein the merchandise registration device is a POS terminal.

8. A maintenance support system, comprising:
a merchandise registration device;
a worker terminal used by a worker who performs maintenance work of the merchandise registration device; and
a maintenance support device for communicating with the merchandise registration device and the worker terminal, respectively, wherein
the merchandise registration device comprises
a first display,
a first transmission component for transmitting first image data displayed on a screen of the first display to the maintenance support device, and
a second transmission component for transmitting operation data related to an operation of the merchandise registration device to the maintenance support device,
the maintenance support device comprises
a first reception component for receiving the first image data transmitted by the first transmission means and a second reception component for receiving the operation data transmitted by the second transmission component,
a generation component for generating second image data including the first image data and the operation data corresponding to the first image data in time, and
a third transmission component for transmitting the second image data generated by the generation component to the worker terminal, and
the worker terminal comprises
a second display,
a third reception component for receiving the second image data transmitted by the third transmission component, and
a second output component for outputting the second image data to the second display.

9. The maintenance support system according to claim 8, wherein
the output component outputs a list of information for specifying the second image data.

10. The maintenance support system according to claim 8, wherein
the second image data is image data transitioned over time.

11. The maintenance support system according to claim 8, the maintenance support device further comprises a component that acquires image data of a frame image displayed on the screen of the touch panel of the merchandise registration device, with each acquisition of the image data of the frame image, stores the acquired image data in an image file, and adds a data name to each image data, the data name including a date and time at a time of acquiring the image data.

12. The maintenance support system according to claim 8, wherein the first acquisition component acquires first image data displayed on the screen of a display of a plurality of merchandise registration devices.

13. The maintenance support system according to claim 12, wherein
the generation component generates a maintenance support screen based on data collected from each of the plurality of merchandise registration devices.

14. The maintenance support system according to claim 8, wherein the merchandise registration device is a POS terminal.

15. A control method for causing a computer of a maintenance support device to perform functions comprising:
acquiring first image data displayed on a screen of a display of a merchandise registration device;
acquiring operation data related to an operation of the merchandise registration device;
generating second image data including the first image data and the operation data corresponding to the first image data in time; and
outputting the second image data generated.

16. The control method according to claim 15, further comprising:
outputting a list of information for specifying the second image data.

17. The control method according to claim 15, further comprising:
transitioning the second image data over time.

18. The control method according to claim 15, further comprising:
acquiring image data of a frame image displayed on the screen of the touch panel of the merchandise registration device;
with each acquisition of the image data of the frame image, storing the acquired image data in an image file; and
adding a data name to each image data, the data name including a date and time at a time of acquiring the image data.

19. The control method according to claim 15, further comprising:
acquiring first image data displayed on the screen of a display of a plurality of merchandise registration devices.

20. The control method according to claim 19, further comprising:
generating a maintenance support screen based on data collected from each of the plurality of merchandise registration devices.
